(19) United States
(12) Patent Application Publication
(10) Pub. No.: US 2004/0254802 A1
(43) Pub. Date: Dec. 16, 2004

(54) Secure collection and delivery system

(76) Inventors: Stuart James Miller, Oxfordshire (GB); Daniel Robert Turner, Buckinghamshire (GB)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/496,928

(22) PCT Filed: Nov. 26, 2002
(86) PCT No.: PCT/GB02/05312

(30) Foreign Application Priority Data
Nov. 26, 2001 (GB) 01282672

(51) Int. Cl. G06F 17/60

(52) U.S. Cl. 705/1

(57) ABSTRACT

A system for the collection and delivery of goods, particularly to and from automated delivery and collection points or lockerbanks, uses the customer's telephone number or email address as an identifier for each delivered item. Each customer's preferred delivery address is stored on a database and accessed by means of the identifier. When ordering goods, the customer gives his telephone number or email address to an etailer who marks this on the package as the sole means of addressing the package. The identifier may also be used by the delivery person or the customer to access the automated delivery facility. Optionally the delivery person must also enter a code identifying himself, and the customer must also enter a security PIN number when collecting his goods. Alternatively a one-time collection code is generated for each delivery and communicated to the customer, who enters it together with his identifier when collecting the delivered item. Alternatively the customer enters the recipient's identifier into a lockerbank together with a package, and the lockerbank communicates the identifier automatically to the delivery organisation to initiate collection and delivery of the package. The system offers increased convenience for customers ordering goods or services over the telephone or internet.

This invention relates to secure delivery or collection systems and, in particular, to systems for the delivery and collection of goods to and from secure lockers in response to orders received over the internet or telephone.

Today, goods may typically be purchased by customers through store-based retailing or by contacting a vendor via telephone or mail. They may go to a retail store and conduct the purchase through a sales assistant or store-based retailing systems, or conduct the purchase over the telephone by calling the vendor directly—this is usually in response to seeing the product in a vendor's catalog or seeing an advertisement for the product on the television, radio or other medium, so called catalog-based retailing.

Recently, a third approach to retailing has evolved: buying goods over the internet. Customers select their goods from the choice available on a vendor's web page. Payment is conducted typically with a credit card, which is authorized at the point of purchase. This retail approach is referred to as “etailing”; vendors using the etailing model are referred to as “etailers”. Etailing has a number of advantages over both store-based retailing and catalog-based retailing but there remains a key challenge for all of the channels described; getting the goods to the customer in a way that is cheap and convenient. Catalog-based retailers have always faced a similar challenge, which is one of the main reasons why the growth of catalog-based retailing has been curtailed. So if retailers and etailers are to fulfill their potential, they need to address the problems with the current delivery infrastructure.

Many businesses also face similar problems in forwarding parts to service engineers or any other form of mobile work force. The current logistics infrastructure has difficulty in keeping up with new, more efficient ways of working. For example, a photocopier service engineer may be based in one place but cover a wide geographical area in terms of customer base. It may be necessary to deliver spare parts overnight in order that the mobile engineer can start work promptly next day. However actually getting the spare parts to the engineer in the middle of the night can be problematic.

Therefore the two problem areas with the current delivery infrastructure are cost and convenience. Each of these problems will now be discussed.

Delivering individual packages to individual customers' homes, or to an individual at a company, is an inefficient process compared with delivering whole batches of products to retail stores or company premises. This inefficiency is compounded further by the fact that customers are often not in to receive the delivery. Understandably, it is difficult for delivery companies to give a specific time when a customer's package will be delivered; in fact, they could give specific times but this would make the system even more inefficient and therefore increase the cost even further. But it is equally understandable that customers are unwilling to wait in for a vaguely-specified time period often spanning several days to take receipt of their package.

The result is that the delivery company either leaves the parcel outside the customer's home, which is clearly a security risk as it invites theft, or leaves a note explaining that they tried to deliver the package but the customer was not in. The delivery company will either try to deliver the package again or will ask the customer to collect it from the delivery company's depot between certain times, which is inconvenient for the customer and inefficient for the delivery company.

In summary, the current process is inconvenient and inefficient. It is inconvenient for customers because they either have to try to wait in for the delivery, which could mean waiting in for several days, or go to the delivery depot at a certain time. It is inefficient for delivery companies because delivering single packages to individual customers' homes is more expensive than delivering multiple packages to retail stores, and because customers are often not in to receive their deliveries. The delivery companies' inefficiencies result in increased costs, which result in increased delivery fees. This limits further the appeal to customers of buying goods from retailers or etailers.

Some customers and businesses have responded to this situation by arranging for goods purchased to be delivered to an automated delivery facility as described in the prior arts However the success of these facilities lies with integrating this new technology into existing supply chains, which themselves were established long ago to serve the traditional catalogue retailing business. The prior art describes the use of electronic delivery lockers to receive packages and provide an electronic proof of receipt when the delivery cannot be made.

These machines often require some form of code (Delivery Code) to be inputted to gain access to the delivery or collection functions. A different code (Collection Code) can then be inputted to provide the consumer with access to collect or return a package.

These codes can be passed from the customer to the retailer along with the physical address of the automated delivery facility (for the benefit of the logistics company). The logistics company or delivery organisation delivering the package can then enter the Delivery Code when they arrive at the facility to place the goods inside a locker.

One problem arises when considering how to pass the Delivery Code and the delivery address from a customer to a supplier of goods or service provider. The second arises when considering how to pass the Delivery Code and the delivery address from the retailer or service provider to the delivery organisation.

In the first instance the customer must remember their Delivery Code to pass this information to the retailer and must then remember the address of the automated delivery facility into which they wish to have the package delivered. In the second instance the retailer must then add this Delivery Code and address to the package in a format that the delivery company can read and use.

The object of this invention is to provide an improved collection or delivery system which is more convenient in use.

According to a first aspect of the present invention there is provided a system for the collection and/or delivery of at least one item from a collection address to a delivery address, by a delivery organisation serving a plurality of customers, the delivery organisation including a database containing a plurality of said addresses; characterised in that the database further includes a plurality of identifiers, each identifier being a telephone number or email address associated with a customer and with at least one said collection or delivery address, and further characterised in that the item is identified by an identifier, and the collection or delivery address for that item is retrieved from the database by means of the said identifier.

According to a second aspect the present invention provides a system for the collection and/or delivery of at least one item from/to at least one automated delivery facility, the system including a delivery organisation serving a plurality of customers; the automated delivery facility including at least one secure enclosure, locking means for regulating access to the enclosure, and security code input means for controlling the locking means; characterised in that there is provided a database containing a plurality of identifiers, each identifier being a telephone number or email address associated with a customer; and the locking means unlocks the enclosure when at least a first said identifier is entered into the security code input means.

According to a third aspect the present invention provides a system for the delivery of at least one item from an automated delivery facility to a delivery address, by a delivery organisation serving a plurality of customers, the delivery organisation including a database containing a plurality of delivery addresses, the automated delivery facility including at least one secure enclosure; characterised in that the database further includes a plurality of identifiers, each identifier being associated with a customer and with at least one delivery address, and the automated delivery facility includes identifier input means and identifier communication means; and further characterised in that, when the item is placed in the enclosure and the said identifier is entered into the identifier input means, the communication means associates the identifier with the item placed in the enclosure, and communicates the identifier to the delivery organisation so as to initiate the collection of the item from the enclosure by the delivery organisation; and the delivery address for that item is then retrieved from the database by means of the said identifier entered into the identifier input means.

In a first embodiment of the system, a customer of a delivery organisation registers his mobile telephone number or email address with the delivery organisation. The customer may be a private individual, or a company or organisation, such as a supplier of goods or services. The delivery organisation operates a network of automated delivery facilities. An automated delivery facility may be a secure automated delivery and collection point, such as a bank of secure enclosures, known as a “lockerbank”. Alternatively an automated delivery facility may be an individual secure delivery box, having one secure enclosure, located at the customer's home or at retailer's or service provider's premises. The customer informs the organisation which automated delivery facility, such as a local lockerbank, is the most convenient for him to use for dispatching or collecting goods. This information is stored by the delivery organisation in a database, which is conveniently a computer database. The mobile phone number or email address forms an identifier by which the customer's details, including his preferred lockerbank address, alternative lockerbank addresses, and other details such as billing information and home address, may be accessed and identified.

The database contains details, including preferred delivery and collection addresses, of many or all of the customers of the delivery company. At least some of these addresses and at least some of these customers are associated, each with an identifier. Each identifier is associated with a customer, being either an individual or company or group of individuals, and also associated with one or more addresses. The customer may specify which associated address is the preferred address for collection or delivery. Each identifier is preferably a mobile telephone number or email address relating to one of the customers. Thus for each of these customers, the customer's preferred delivery or collection address, which may be the address of the customer's local lockerbank, is stored and indexed by the customer's telephone number or email address.

In use, the customer rings a supplier of goods and orders an item or package. The customer gives the supplier his mobile phone number or email address, and the supplier writes it on the package as the identifier, without any other details. The package is thus identified solely by means of this identifier. The delivery organisation picks up the package, and looks up the customer's preferred lockerbank address (the delivery address) on its database from the mobile phone number or email address written on the package, and delivers the package to that lockerbank. Alternatively the customer could have an individual secure delivery box at their home, and the package is delivered there.

In a further example of use of the system, the customer has a package for delivery to another customer or to a service provider. For example, the customer wants to have his laundry delivered to a dry cleaner. The intended recipient is also a customer of the delivery organisation, and the dry cleaner's preferred lockerbank or private secure delivery box address is stored on the database, and identified by the telephone number or email address (the identifier) of the dry cleaner. The customer writes the dry cleaner's mobile phone number or email address on the package, without any other details, and puts it in his local lockerbank, or alternatively in his private secure delivery box, and arranges collection by the delivery company. The delivery organisation picks up the package, which is identified solely by the identifier marked on it by the customer, and retrieves the recipient's preferred lockerbank address or secure delivery box address (the delivery address) from the database by means of the identifier (mobile number or email address), and delivers the package.

Alternatively the customer may telephone the dry cleaner and give them his mobile telephone number. The dry cleaner passes this to the delivery organisation, optionally along with their own telephone number. The delivery organisation looks up the customer's mobile telephone number on the database to get the collection address, and collects the parcel of laundry. The customer may have written the dry cleaner's telephone number on the parcel, or alternatively the delivery organisation records it when it receives the call from the dry cleaner. The delivery organisation looks up the dry cleaner's telephone number (identifier) on the database to get the delivery address, and delivers the parcel to the dry cleaner's secure delivery box.

In an alternative embodiment, the customer places an item for collection at an automated delivery facility, such as a shared lockerbank comprising a bank of secure enclosures, or an individual secure delivery box at the customer's home. The automated delivery facility is provided with identifier input means, such as a keypad or a card reader, or any other suitable means, and the customer enters an identifier (for example, the email address of the intended recipient of the package) into the input means, and places the item in an available locker. The door is automatically locked.

The identifier input means may also function as security code input means, so that the identifier works both as a security code regulating access to the enclosure, and as the identifier used to retrieve the delivery address for the package. Alternatively the customer enters first, his own identifier, which allows him access to the enclosure, and then the identifier of the intended recipient of the item. Both these identifiers may be communicated to the delivery organisation and associated with the item, allowing the history of the delivery and the deposit of the item by the customer to be recorded.

The input means communicates at least the recipient's identifier to an identifier communication means, which is also built into the lockerbank, which associates the email address entered by the customer with the item in the enclosure or locker. This communication means then automatically sends a message to the delivery organisation to initiate collection of the item.

The intended recipient may be integrated with the delivery organisation—for example, the delivery organisation offers laundry or other services—or may interact with the delivery organisation to arrange deliveries and collections to and from its customers—in which case the message is sent to the recipient of the item. Alternatively a message may be sent, both to the delivery organisation and to the intended recipient.

When the delivery organisation receives the message it collects the item from the automated delivery facility, and looks up the identifier on the database to retrieve the delivery address for the item. The item is then delivered to the intended recipient. Where a message has also been sent to the recipient, the recipient may be expecting the package, and will go to collect it. Alternatively he may be sent a message on delivery.

Alternatively the customer may identify themselves at a lockerbank using their mobile phone number, enter their PIN code (as discussed further below), and then enter the recipient's mobile phone number before placing the package in an available locker. This information may then be passed on to a delivery company to determine the correct delivery address (or lockerbank) as specified by the preference of the recipient, and recorded in the database alongside the recipient's identifier.

The retailer or etailer using the system and the delivery organisation may be integrated with each other, or the retailer or etailer may perform some of the functions of the delivery organisation, including the management of the database. Similarly the delivery organisation may work with a number of independent delivery organisations. The delivery organisation and these independent delivery organisations may be integrated with each other, or each may perform some of the functions of the other, including the management of the database.

Furthermore, a customer may place a package in an automated delivery facility to be picked up by another customer from the same automated delivery facility. In this case the delivery organisation need not undertake the physical carriage of the item, and the system operates allows customers to use automated delivery facilities to deliver goods directly to or from other customers. For example, late in the evening, a customer of a laundrette drops his dry cleaning in to an automated delivery facility or secure delivery box managed by the delivery organisation, and located in the street outside the laundrette. The laundrette picks up the dry cleaning in the morning and cleans it, then places it back in the locker to be picked up by the customer. Hence both the customer and the laundrette are customers of the delivery company, which merely manages the automated delivery facility and facilitates the transfer of goods between the customers by means of the identifiers entered into the facility when the goods are deposited or collected.

The term “delivery organisation” is therefore to be construed as including the abovementioned and equivalent arrangements, and including an organisation which manages one or more automated delivery facilities without necessarily undertaking the physical carriage of goods.

The present system addresses the customer inconvenience of having to pass their Delivery Code and the physical delivery address to the retailer, by using their mobile or fixed telephone number or email address or number as the only form of address on the package. This makes the system much more convenient in use. In this specification, “email address” is taken to be synonymous with “email number”. This is an easy number for the customer to remember and the retailer or logistics company may then determine the customer's preferred delivery address by comparing with a customer related database table.

The present system also addresses the inefficiency caused by retailers in having to interpret, manage and pass the delivery information on to the delivery company in a format which they themselves can interpret, manage and use. A customer's mobile or fixed telephone number or email number is unique and in a standard format which can be easily interpreted and used by retailers and delivery companies alike. No further delivery information is required on the package for these companies to use the automated delivery and return facilities described in the prior art.

The present system also benefits in that it may be deployed rapidly. In order for this invention to be rapidly deployable, it must have a very high level of automation and be very simple to use both for delivery personnel and customers. If the system is too labour-intensive then its deployment is likely to be restricted both by the availability of suitable personnel and the time taken to train them.

The invention simplifies the addressing requirements when operating a network of automated delivery and collection points, or ADCPs, such as lockerbanks. The automated delivery and collection points facilitate the delivery of goods to a customer and the collection of goods from a customer. In particular, the invention allows customers, businesses, delivery agents, or retailers to arrange for the delivery of goods ordered from a retailer to an automated delivery and collection point which can be accessed by a customer. The invention also allows customers, delivery agents, or retailers to arrange for the collection of goods ordered from a retailer to an automated return point which can be accessed by a customer.

An automated delivery and collection point comprises a bank of electronically-operated lockers. The lockers may vary in size, and may be positioned indoors or outdoors. The ADCP may include different type of interfaces, such as barcode readers, smart card readers, biometric scanners, or keypads.

The ADCP is connected via a network medium to a collection of one or more servers referred to as a Locker Management System. A Locker Management System (LMS) may control two or more ADCPs. These ADCPs may be located at separate geographical locations.

Whilst providing physical addressing and routing information for the retailer and delivery organisation, the identifier may also be used by the delivery company and/or the customer to access an automated delivery facility, which may be a secure automated delivery and collection point comprising a plurality of secure enclosures, or alternatively a secure delivery box comprising one secure enclosure.

The facility includes locking means for regulating access to the enclosure, and security code input means for controlling the locking means. The security code input means includes a keypad, scanner, or any equivalent means for entering the identifier and other security codes as discussed below, associated with the customer or delivered item. The security code input means then compares the entered identifier and other inputs with the correct values, which may be generated or stored for example at the facility, in the database, or elsewhere in the delivery organisation. If the entered values are correct then the security code input means instructs the locking means to unlock the enclosure to allow access for the delivery or collection of the item. The process of comparison and validation of the inputs to the security code input means may take place at the facility or elsewhere, by means for example of hardwire or wireless data links, and the technology for accomplishing this is well known in the art.

Rather than specifying home or work as the ship-to address, customers or etailers may arrange for goods to be shipped to a local ADCP using only a mobile or fixed telephone number or email number. When a package is delivered to an ADCP site, it is identified to an interface on the ADCP by its mobile phone number or email number.

In an alternative embodiment, the mobile phone number or email number may be embedded in the ADCP site address on the ship-to label on the package.

In a further alternative embodiment, the mobile phone number or email number may be encoded as a bar code on a label on the package—this bar code may be scanned on a bar code scanning interface coupled to the automated delivery and collection point.

Alternatively, the mobile phone number or email number may be transmitted wirelessly to a detector coupled to the automated delivery and collection point. Alternatively, the mobile phone number or email number may be typed into a keyboard in communication with the automated delivery and collection point. Upon validating the mobile phone number or email number, the automated delivery and collection point will open to permit access, so that the package may be placed into an appropriately-sized secure locker.

The delivery organisation may employ many delivery personnel. Desirably, each delivery person, or alternatively each group or organisation of delivery personnel, is issued and associated with an individual access code, and a list of these access codes is held by the delivery organisation, for example on the computer database or on a separate database. When delivering an item to the facility, the delivery person enters the access code into the security code input means together with the identifier. This identifies the person making the delivery and also identifies the item. The locking means then unlocks the enclosure and the item is placed inside, the enclosure then locking again to await the customer.

The delivery organisation may also include collection code generating means and collection code communication means, located for example centrally or at each automated delivery facility. When the item is delivered to the automated delivery facility by another customer or by the delivery organisation, the collection code generating means then generates a one-time collection code, and the collection code communication means communicates this collection code to the customer awaiting the delivery. Desirably, the identifier is the customer's email address or telephone number, and the communication means merely sends a message including the collection code to this email address or telephone number.

For example, the communication means generates a message saying “a parcel has been delivered for you in locker no. 7 in lockerbank no. 27 on the junction of First Street and Broadway. Please note the following collection code and input this code to collect your parcel: 66756.” The communication means sends this message automatically to the customer whose identifier was input into the lockerbank by the customer or delivery person making the delivery, or associated with the item centrally (for example, typed into a computer system managing the lockerbank) by the delivery organisation. The locking means unlocks the enclosure when the identifier associated with that item and customer (the intended recipient) is entered into the security code input means together with the collection code relating to the item.

Alternatively, the system includes collection message generation means and collection message communication means, located for example centrally or at the automated delivery facility. The generation means generates a message informing the customer that a parcel has been delivered to the facility, for example by another customer or by a delivery person. The parcel is associated with an identifier, for example by inputting the identifier into the facility when the parcel is delivered, or by inputting it centrally into a computer network which manages the facility. The communication means then communicates the message to the customer who is associated with the identifier; conveniently, the message is sent to the email address or telephone number which forms the identifier. The message might read: “a parcel has been delivered for you to XXX lockerbank. Please input your telephone number/email address and PIN code when collecting your parcel.”

The customer then inputs their identifier and its associated PIN code into the lockerbank, which then opens the locker containing the parcel.

Thus upon receipt of the package by the automated delivery and collection point, the customer is automatically sent a message containing notification of the delivery, and including a collection code, such as a numeric code, for opening the locker. Optionally, this code will only work when used in conjunction with a pre-determined customer PIN.

Alternatively the customer may input their mobile phone number or email address at a lockerbank to open the locker or lockers containing their goods.

Optionally, this code will only work when used in conjunction with a pre-determined customer PIN. In this case, the database also includes a plurality of PIN codes or PIN numbers, each PIN number being associated with an identifier and hence with the customer associated with that identifier. For example, a customer gives the delivery organisation his mobile telephone number, and this becomes his identifier; the delivery organisation then generates a PIN number, and sends this to the customer. Every time the customer wants to pick up a delivery, he enters his identifier into the security code input means together with its associated PIN number, and the locking means unlocks the enclosure.

The customer will come to the ADCP site to collect their goods. Alternatively, the ADCP may be affixed to the customer's residence. The ADCP interface may prompt the customer to enter their collection code followed by their PIN. The collection code and PIN will be validated by the ADCP site and the server computers used to manage the network of ADCPs. If the validation is successful, the locker containing the customer's goods will open.

The retailer or etailer, or the delivery organisation, will look up the telephone number or email address on a database to determine the physical address that they are being asked to deliver the package to, and then attach this address to the package by various means already described.

Alternatively, the retailer or etailer, or the delivery organisation, will look up the telephone number or email number on a database to determine the physical address that they are being asked to deliver the package to, and then attach routing information to the package by various means already described.

In a further embodiment, the end user or customer is able to associate a temporary delivery address with their telephone or email number which will override their usual settings.

The system enables the end user to send goods directly to another registered user of the system by simply adding the addressee's telephone number or email address to a package.

One scenario according to the invention may take place as follows. The sender in this scenario is called Dan. He wraps up the package and takes it to his nearest lockerbank. When he gets to the lockerbank he may be required to identify himself by typing his identifier, which is his phone number or email address, into the keypad on the lockerbank. The customer thus does not need to be provided with a barcoded ID card or other special form of identification, nor to remember to carry such a card with him. He merely enters his mobile phone number or email address, which is already familiar to him, in order to identify himself. This saves cost and complexity in the management of the system, and simplifies not only the process of dispatching a parcel but also the procedure for registering a new customer of the service, since no identity card or the like needs to be generated and sent to the customer.

The network looks up the mobile phone number on its database to identify the sender, and returns an acknowledgement and greeting message to the sender. Optionally, the sender is then required to enter a security PIN number which is compared by the network with the PIN stored in association with the sender's mobile phone number. The message might read “Hello Dan. Please enter your PIN.”

The current status of the sender may also be checked to ensure that he is entitled to use the service—for example, whether he has paid his account up to date. The sender may be given the option of using the recipient's account rather than his own. Rules for allowing or refusing such cross-charging options may also be stored on the database, and customers of the system may specify whether and under what circumstances they will allow a sender to send them a parcel which will be charged to their account as the recipient.

Alternatively, no identification may be required from the sender.

The lockerbank then requests the sender to identify the intended recipient of the parcel. A number of alternative options may be given for doing this, including the option of entering the recipient's mobile (or landline) phone number or email address, which has been recorded as the recipient's identifier. Thus a message may be displayed: “is this a mobile-to-mobile delivery?” Dan presses “yes” and the lockerbank prompts him to enter the phone number or email address of the recipient. Again, since this a unique identifier which is easily remembered by the sender, the sender does not need to carry with him any special identifying number or other record of the recipient's address or identity. This enables the sender to easily and simply dispatch the parcel to its intended recipient.

The sender types the recipient's mobile phone number or email address into the lockerbank. The system then looks up the mobile phone number or email address on its database of customers, and identifies the recipient as a registered customer. It may also display a confirmatory identification of the recipient, such as the name and/or address, or part of the name or address, of the recipient, to ensure that the sender has entered the correct details. The sender may also be required to enter the details twice by way of confirmation and to prevent mistakes.

The locker door is then opened automatically and the sender places the parcel inside and shuts the door. The sender may first write the recipient's email address or phone number on the parcel. Alternatively or additionally, the lockerbank prints out a label with the recipient's identifier (email address or mobile phone number) on it, and/or with the address of the receiving lockerbank. This may be a code number for the receiving lockerbank, which will be recognised by the collection and delivery personnel. For example, the label might read “steve@mailshop.com Lockerbank NEE 456”. Alternatively a tracking number or barcode may be printed on the label which can be used by the delivery personnel to identify the delivery address.

When the delivery company goes to collect the parcel, the delivery person identifies himself and the lockerbank opens automatically, one by one, each locker which holds a parcel for collection by that delivery company. For example, where all mobile-to-mobile deliveries are carried out by delivery company A, then all lockers holding such parcels will open, one by one, when the delivery person from company A identifies himself to make the collection.

A label for each parcel may be printed out for the sender to stick on the parcel before putting it in the locker, or alternatively when the locker door holding that parcel is opened by the delivery company. Thus for example the label details for the parcel in a given locker may be stored in a memory in the lockerbank and sent to a printer in the lockerbank when the door to that locker is opened. Alternatively the preferred delivery address (such as a code identifying a preferred lockerbank) of the intended recipient may be downloaded from the system's central database when the parcel is collected by the delivery person. This enables the recipient to update his preferred delivery address right up until the time that the parcel is collected by the delivery person. It is even possible for the most recently logged location of the mobile phone of the recipient to be used to automatically identify the location of the preferred lockerbank for delivery. The delivery person then applies the self adhesive label to the parcel and takes the parcel to the sorting depot.

The parcel is delivered to the recipient's preferred lockerbank, and when the delivery person arrives he identifies himself, and types or scans in the mobile phone number or email address shown on the parcel. The system then opens one of the locker doors and the delivery person puts the parcel inside and closes the door. The system then automatically sends a collection message to the recipient's mobile phone or email box, including a one-time PIN number which the recipient must enter into the lockerbank when he goes to collect his parcel. When the recipient goes to collect his parcel he enters his mobile phone number or email address into the lockerbank to identify himself, and is then prompted for his one-time PIN number. When he enters the one-time PIN number for that parcel, the door opens and he collects his parcel.

By using a familiar and easily recognisable and memorable identifier, such as the customer's phone number or email address, both for dispatch and for collection of the parcel, there is thus no need to generate and record a special ID number which must be recorded by each customer, for example by encoding it on a card, and entered into the lockerbank each time a delivery or collection is made. The delivery and collection process thus becomes a simple extension of the customer's everyday routine, without requiring him to carry a special ID card or the like. Since each customer's PIN number may simply be a four digit number, and does not need to be sufficiently long to provide a unique identifier, this too can be easily memorised. Preferably the customer may choose their own PIN number when registering with the system.

Where the recipient's phone number or email address is shown as the identifier on the parcel, the delivery company may also use this to contact the recipient directly in the event that the delivery person encounters a problem in delivering the parcel. This again simplifies the process of delivery.

The foregoing description of various embodiments of the invention has been presented for purposes of illustration only. It is not intended to limit the invention to the precise forms disclosed. Many modifications and equivalent arrangements will be apparent from the foregoing description.

1-10. Canceled.

11. A system for the collection and/or delivery of at least one item from a collection address to a delivery address, by a delivery organization serving a plurality of customers,
the delivery organization including a database containing a plurality of said addresses;
characterized in that the database further includes a plurality of identifiers,
each identifier being a telephone number or email address associated with a customer and with at least one said collection or delivery address,
and further characterized in that the item is identified by an identifier,
and the collection or delivery address for that item is retrieved from the database by means of the said identifier.

12. A system for the collection and/or delivery of at least one item from/to at least one automated delivery facility,
the system including a delivery organization serving a plurality of customers;
the automated delivery facility including at least one secure enclosure, locking means for regulating access to the enclosure, and security code input means for controlling the locking means;
characterized in that there is provided a database containing a plurality of identifiers,
each identifier being a telephone number or email address associated with a customer;
and the locking means unlocks the enclosure when at least a first said identifier is entered into the security code input means.

13. A system for the delivery of at least one item from an automated delivery facility to a delivery address, by a delivery organization serving a plurality of customers,
the delivery organization including a database containing a plurality of delivery addresses, the automated delivery facility including at least one secure enclosure;
characterized in that the database further includes a plurality of identifiers,
each identifier being associated with a customer and with at least one delivery address,
and the automated delivery facility includes identifier input means and identifier communication means;
and further characterized in that, when the item is placed in the enclosure and the said identifier is entered into the identifier input means, the communication means associates the identifier with the item placed in the enclosure, and communicates the identifier to the delivery organization so as to initiate the collection of the item from the enclosure by the delivery organization;
and the delivery address for that item is then retrieved from the database by means of the said identifier entered into the identifier input means.

14. A system according to claim 3, characterized in that the said identifier is a telephone number or email address relating to a said customer.

15. A system according to claim 1, characterized in that the said identifier is marked on the item, and the item is collected by the delivery organization and identified thereafter by means of the said identifier marked on the item.

16. A system according to claim 1, wherein the item is delivered to an automated delivery facility including at least one secure enclosure, locking means for regulating access to the enclosure, and security code input means for controlling the locking means;
characterized in that the item is associated with the said identifier,
and in that there are provided collection code generating means and collection code communication means;
the item being delivered to the automated delivery facility, and the collection code generating means then generating a first collection code,
and the collection code communication means communicating the first collection code to a customer associated with the said identifier;
and further characterized in that the locking means unlocks the enclosure when the first identifier is entered into the security code input means together with the first collection code.

17. A system according to claim 1, wherein the item is delivered to an automated delivery facility including at least one secure enclosure, locking means for regulating access to the enclosure, and security code input means for controlling the locking means;
characterized in that the item is associated with the said identifier,
and in that the database further includes a plurality of PIN numbers, each PIN number being associated with an identifier;
and further characterized in that there are provided collection message generating means and collection message communication means,
whereby when the item is delivered to the automated delivery facility, the collection message generating means generates a message advising the customer associated with the first identifier of the delivery,
and the collection message communication means communicates the message to the said customer;
and in that the locking means unlocks the enclosure when the first identifier is entered into the security code input means together with an associated PIN number.

18. A system according to claim 1, characterized in that the system includes at least one supplier of goods, and the said identifier is communicated from a customer to the supplier in order to arrange the delivery of the item from the supplier to the customer.

19. A system according to claim 1, characterized in that the system includes at least one service provider, and the said identifier is communicated from a customer to the service provider in order to arrange the delivery of the item from the customer to the service provider.

20. A system according to claim 1, wherein the item is collected from an automated delivery facility including at least one secure enclosure, locking means for regulating access to the enclosure, and security code input means for controlling the locking means; characterized in that the delivery organization further includes a plurality of delivery personnel and a list of access codes, each access code being associated with one of the said delivery personnel,
and in that the locking means unlocks the enclosure to enable the collection when the said identifier is entered into the security code input means together with a said access code.
